(19) United States
(12) Patent Application Publication
(10) Pub. No.: US 2024/0202208 A1
(43) Pub. Date: Jun. 20, 2024

(54) END-TO-END DATABASE MANAGEMENT FRAMEWORK

(71) Applicant: PATTERNS DATA SYSTEMS INC., San Francisco, CA (US)

(72) Inventors: Kenneth Van Haren, San Francisco, CA (US); Christopher Cziraky-Stanley, San Francisco, CA (US)

(21) Appl. No.: 18/082,563

(22) Filed: Dec. 15, 2022

(51) Int. Cl. G06F 16/25; G06F 16/26

(52) U.S. Cl. CPC G06F 16/258; G06F 16/254; G06F 16/26

(57) ABSTRACT

An integrated end-to-end data management programming and environment, as well as methods of end-to-end data management are described. A user of the described systems and methods can design and deploy a data pipeline project to import data from third party data sources, to perform data functions, and to store output data in a data warehouse. The user can write data pipeline projects, applications, and programs in the form of data graphs, where graph nodes perform the data pipeline functions. In some embodiments, the user can download entire task- or server-specific data graphs or portions of a data graph from a library of pre-configured objects.

### FIELD

This application relates to the field of database technology and more particularly to the field of frameworks for developing and deploying a data pipeline project.

### SUMMARY

The appended claims may serve as a summary of this application.

### BRIEF DESCRIPTION OF THE DRAWINGS

FIG. 1 illustrates an example data management system.

FIG. 2 illustrates an example implementation of the embodiment of FIG. 1.

FIG. 3 illustrates a diagram of the execution aspect of a graph.

FIG. 4 illustrates an example user interface of the embodiment of FIG. 1.

FIG. 5 illustrates a block diagram of an example architecture of the embodiment of FIG. 1.

FIG. 6 illustrates a method of an example operation of the embodiment of FIG. 1.

FIG. 7 illustrates a method of an example operation of preparing a graph for execution.

FIG. 8 illustrates a method of an example data pipeline execution.

FIG. 9 illustrates a method of generating and using a library of data management objects.

FIG. 10 is a block diagram that illustrates a computer system upon which one or more described embodiment can be implemented.

### DETAILED DESCRIPTION OF THE DRAWINGS

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Data plays a major role in modern life. Various technology areas can take advantage of the wealth and depth of insight that can be gained from data. For example, massive collection of data on the output of various sensors can be used in improving machine learning models that are used in various industries, such as health, computing, and autonomous driving. Consumer data can be used for gaining insight into designing better products. Businesses use sales data to chart various business analytics to further derive insight and strategy in their field. In all these applications, various data engineering and data management tools are used. For example, the raw data typically exists in a third-party server that the user of the data extracts into a data warehouse. The raw data gleaned from the various corners of the Internet then is processed into usable, actionable output, based on the needs of the industry of the user of the data.

A machine learning engineer might import data from various third-party sources online into a data warehouse and then write custom code to process the raw data into usable machine learning training or test datasets. A business analytics data user may write custom code to collect raw data from some target third-party sources online and store the raw data into a data warehouse. The business analytics user can write further custom code to process the data into useful, and actionable business analytics, such as revenue charts, cost analysis, market data, trends, and other business analytics outputs. In most of these applications, the data engineer may need to code and design data management stacks including operations such as extracting raw data from one or more third-party sources, modifying and storing the raw data in a data warehouse and producing an output from the stored data. The output depends on the particular industry and the application for which the data engineer is utilizing the data warehouse.

In some applications, the data management stack can further include exporting some data, including a modified version of an imported data into third-party databases. Furthermore, software development for a data engineer includes concerns, such as execution and observation (testing) of the operations of the data pipeline, which includes the operations of a data warehouse.

Existing tools can enable a data engineer to perform the functions of extracting, storing, processing and exporting data via a combination of different tools. Furthermore, different combinations of the tools can enable a data engineer to implement these functions, execute them and perform software development jobs, such as observation, testing and ongoing maintenance. However, a challenge facing the data engineer using a disparate collection of tools is the substantial development effort involved in integrating the various different tools, synchronizing their operations, and managing their interoperability. This task often involves developing custom code for a data engineer to be able to use tools from different vendors for various parts of a data pipeline project, such as extracting, storing, modeling and processing the raw data and exporting the processed data. For example, some tools are directed to modeling data, including performing transformation of the raw data obtained from third-party sources based on the requirements of the environment of the user of the data. Yet other tools are needed to orchestrate the execution of the data functions. However, the orchestration and execution tools have no inherent interoperability with the data modeling tools and have no access to their metadata. Consequently, the interoperability of the tools should be developed independently by the data engineer and further specified based on the environment of the user of the data. Once the data is extracted, processed and stored in a data warehouse (for example, using a custom-built data modeling and execution tool), yet another tool may be needed to generate the domain-specific outputs demanded by a user of the data. For example, a separate tool may be used to generate human-readable charts based on modeled and executed data in a data warehouse. In other words, the functionality and operations of a data pipeline, from extraction, modeling, warehousing to outputting and exporting, are split across multiple platforms and frameworks. A typical data pipeline may require cross platform custom-coding and interoperability development before launch and during operation. Having to use a collection of tools introduces another challenge in that a data engineer would have to program and consider the requirements of a variety of platforms when designing a data pipeline.

Another challenge facing the data engineer is the lack of standardization in data objects. For example, there are multiple online vendors and sources that may provide “payment” data objects, a data element containing some form of payment information; however, each vendor may use its own formatting of a “payment” data object. Since there is no common data object between various vendors and platforms, development and deployment of data pipelines are slowed down. The same type of data pulled from various sources need to be separately programmed and configured based on the format of the particular data object a pipeline that is supposed to ingest the data.

Finally, another challenge slowing down the development and deployment of data pipelines is the user interface and visualization of the entire pipeline and the tools operating the data pipeline. The operations of a data pipeline can be expressed in terms of a graph, for example a data computational graph or a directed asynchronous graph (DAG). But existing user interfaces can be improved in terms of visualization of the data graph defining a pipeline and the source code underlying a graph. Furthermore, when a data pipeline is split amongst several tools and frameworks, a data engineer does not have an opportunity to view the entire data pipeline in a single user interface, where the data, the code and the output can be viewed and modified in a single interface.

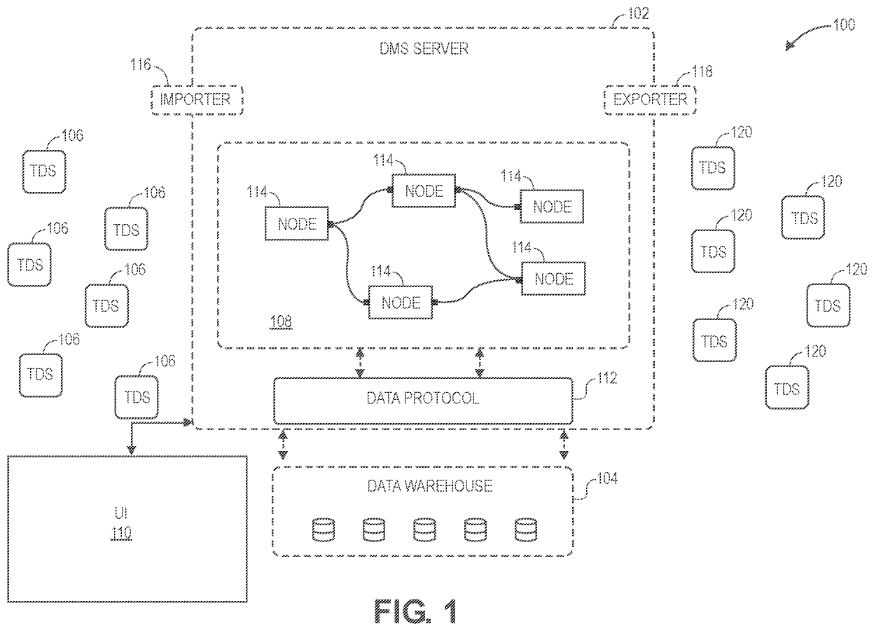

FIG. 1 illustrates an example data management system (DMS) 100 according to an embodiment. The data management system 100 can include a data management server (DMS server) 102, which can be used to manage a data pipeline that includes a data warehouse 104. Various records can be extracted and ingested from third-party data sources (TDS) 106 via application programming interface (API) calls to those providers. Example third-party data sources (TDS) 106 can include, Paypal®, Salesforce®, Stripe®, academic, research and open-source databases and others. The underlying data (records) used can depend on the domain in which the DMS 100 is deployed. In some domains, the third-party data sources can provide tables of records, where tables can include thousands or millions of records each. A data engineer operating the DMS 100 can define the operations of the data pipeline with a graph 108 via a user interface (UI) 110. The UI 110 can be implemented in a variety of ways, such as a locally installed developer kit (Dev Kit), or in the cloud, accessible via a website application, a desktop or mobile application or a combination of these methods. The DMS 100 includes a data protocol 112, which enables the user to define the operations of a data pipeline in one integrated environment.

The graph 108 can define the operation of a data pipeline in terms of nodes 114. Each node 114, written in the data protocol 112, can include an input, an output and a function that generates an output, based on the input of the node. The nodes 114 can also include node and operation dependencies, where execution of a node 114 can depend on execution of another node 114 concluding, thereby defining a data pipeline, via the graph 108. In some embodiments, a node 114 can include sub-nodes, enabling a data engineer to define nested nodes. The data engineer can also define importer nodes 116, which can interface with the TDS 106 for extracting or ingesting raw data. The data engineer defines the graph 108 via the UI 110. The graph 108 is then uploaded to the DMS server 102 for execution.

The DMS server 102 executes the graph 108 ingesting the raw data, performing node functions on the raw data and storing the outputs of the nodes 114 in the data warehouse 104. The data warehouse 104 can include a database environment and a compute environment. The outputs of the nodes 114 depend on the domain in which the DMS 100 is deployed. For example, in the business analytics domain, one output can be a revenue table. In the machine learning domain, an output can be a training dataset having one or more patterns or characteristics. The data warehouse 104 can be provided by a user of the DMS 100 or alternatively can be provided by the operator or administrator of the DMS 100 to a user of the DMS 100, for example a data engineer. In a one scenario, some companies may have their data warehouse 104 hosted on their own servers or a third-party warehouse service provider and may utilize the DMS 100 to manage the operations of their data pipelines that include the data warehouse 104. Other companies may utilize an instance of a data warehouse 104 generated for them by the operator/administrator of the DMS 100. In some implementations, the data warehouse 104 can be provided by service providers such as Amazon®, Google® and others.

In some embodiments, the graph 108 includes exporter nodes 118, which can write the output of one or more nodes 114 into servers of one or more third-party data source (TDS) 120. The TDS 120 may be the same or a different entity than the TDS 106. The exporters 118 may pull data from the node outputs stored on the data warehouse 104 and export to the TDS 120.

The DMS 100 can have a variety of applications, including for example, data extraction and replication from external databases and APIs to a central data warehouse, streaming data ingestion via webhooks, data modeling and pipelines, extract, transform, load (ETL) operations or extract, load, transform (ELT) operations, implementing SQL or Python data transformation functions, training and deploying machine learning models, reverse ETL and/or data syncing between software as a service (SaaS) applications, data visualization and dashboard building, data lineage, schema mapping, documentation, metrics definition, standardization and other applications.

In one aspect, the graph 108 can define the flow of data through related nodes. The graph 108 can be constructed by the implied edges of inputs/outputs of nodes. The graph 108 can contain additional configuration settings such as triggers or parameters that enable customizing the functionality of the nodes within a graph 108. When triggered, individual nodes execute and create data according to their function. Source nodes (with no upstream nodes) can be scheduled to execute or can be a webhook which are triggered by an external API. The graph 108 can execute reactively, unless otherwise configured. That is, all downstream nodes from a source node execute automatically when any new upstream data becomes available. A run of the graph 108 refers to a series of nodes that depend on a source node and are configured to execute in order, once the source node is finished executing.

Furthermore, in the development stage, the nodes can be batteries-included abstractions that enable writing arbitrary code, for example in SQL or Python. A node 114 can include data-friendly methods such as stream_record( ) write_records( ) or set_state_value( ) to process data inputs, store outputs, and track states (e.g., data ingestion state, execution state or any other state variable). In the deployment stage, the nodes can be run in a reactive programming manner, where updating a field or a record by a node can automatically update the entire graph of a data pipeline. A data pipeline implemented and managed with the DMS 100 allows using one tool for managing each part of the data pipeline. Data engineers and data software developers can avoid having to switch between different tools on their browsers or desktop/mobile applications and need not manage multiple log-ins and accounts. Without the benefit of the DMS 100, a data engineer, executing a data pipeline, may have to check the state of several tools/applications, across a variety of platforms, to monitor the state of execution of the pipeline. With the DMS 100, the state of execution of a data pipeline can be monitored in one application/framework and in a single user interface. A change through a schema can propagate through the entire graph. Collaboration between different actors and users of the data is facilitated by using the DMS 100. Additionally, the UI 110 can facilitate visualization and interacting with the entire graph via one interface, as opposed to alternative tools, in which the user may have to switch between several UIs of different tools for various operations of their data pipeline.

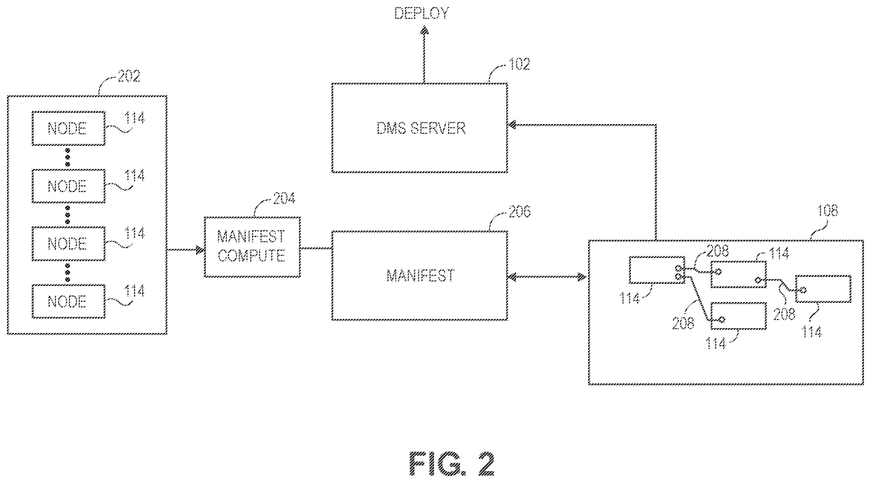

FIG. 2 illustrates an example implementation of the DMS 100, where the DMS server 102 receives a graph 108. A manifest compute 204 can receive a graph holder 202. The graph holder 202 can include the code for each node 114. The manifest compute 204 can construct a manifest 206, which includes all node definitions of the graph 108. The manifest compute 204 can parse the manifest 206 to detect the edges of the graph 108. Each input/output pair between the nodes can define an edge 208 in the graph 108. In this manner, once all the edges of the graph 108 are determined, the graph 108 can be constructed and uploaded to the DMS server 102. The DMS server 102 can deploy the graph 108 and the nodes. In some embodiments, the graph holder 202, the manifest compute 204 and the manifest 206 may reside on a local computer of a user of the DMS 100 and/or be a part of a DevKit installed locally on the user's computer. In other embodiments, the components and operations illustrated in FIG. 2 can entirely reside in the cloud, where user interactions are captured via a browser-based application and handled in the cloud by the DMS server 102.

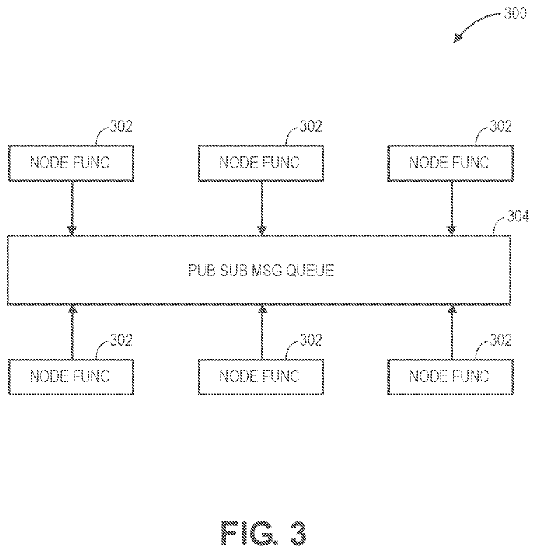

FIG. 3 illustrates a diagram 300 of the execution and run aspect of a graph 108. The node functions 302 are each from a node 114 and can communicate with one another via a publisher/subscriber queue 304. In this manner, when one node is finished its execution, all nodes that depend on that node for their execution receive a message that they can now begin their execution. A run of the graph 108 can include execution of the nodes 114 in the graph 108. Depending on the node functions 302, one or more tables can be generated and stored in the data warehouse 104. Some example node functions 302 can include, generating a table of records (e.g., via an outputTable.createTable, outputTable.append_record), logic functions, cleaning data, formatting or reformatting data, and other functions related to the domain in which the DMS 100 is used.

In some embodiments, the DMS server 102 does not ingest the input data of the nodes; instead, it directs and manages the resources of the data warehouse 104 to ingest the data, perform transformation and generate outputs. In other words, in some embodiments, the subject data of a data pipeline project does not traverse through the DMS 102; instead, the DMS 102 executes the graph 108 of a data pipeline project, causing the data warehouse 104 to perform operations dictated by the graph 108, including ingesting, processing and producing outputs all within the data warehouse 104. In this scenario, the DMS server 102 generates and retains the metadata associated with the execution of the graph 108, which can include one or more mappings of the metadata, the input/output data, timing and other metadata.

### Versioning

In some embodiments, each run of a graph 108 can generate a new version of the graph. In addition, when editing nodes, or adding a new node to a graph 108, the DMS server 102 can generate a new graph version when the edited graph is run. In other words, a new run of the graph 108 generates a new output table in the data warehouse 108 and does not overwrite the previous version of the same output table in the data warehouse 108. The versioning of the graph in this manner can be useful for development and/or observation of the graph 108. For example, each graph run can generate output tables, and metadata related to that run. The output tables can be stored in the data warehouse 104, while the metadata of the runs can be stored in the DMS server 102. In some examples, the metadata includes the timing data of each run. A hash table can store a mapping of the runs, the metadata and the output tables stored on the data warehouse 104. In some embodiments, the metadata of the runs can be used to generate a UI 110 to present the different runs (versions) of a graph 108 as a sequence of node runs. The user can access a version, the metadata of a run and the output data via the UI 110. The DMS server 102 pulls the data from various parts of the DMS 100 to generate a visual and/or interactive presentation of a data pipeline and/or the pipeline execution and versioning on the UI 110.

An example of usage of versioning enabled by the DMS 100 is importing a transaction table from a TPS 106, such as www.stripe.com (Stripe®). A transaction table of Stripe® transactions can be extracted and imported into the data warehouse 104 via a Stripe® API. The transaction table can include thousands or millions of records and importing that amount of data may not be achievable in one run of the graph 108. Consequently, the graph 108 may be run numerous times. The graph versioning enables access to metadata indicating the status of the import in each run of the graph 108. The metadata of each graph run coupled with the output of that particular graph run (e.g., via a hash function) can enable a user to write code and execute various logic functions or node functions 302 on the various versions (runs) of the graph 108. In some embodiments, one or more node functions 302 can include aggregating data from various graph runs (e.g., versions), deduplicating them, unionizing them and generating intermediary or final transaction table outputs. Aside from cases of ingesting voluminous amounts of data, the versioning of the DMS 100 can also be useful in situations where an API providing external data is unreliable or intermittently unavailable. The ability to program on the historic runs of the graph 108 empowers a developer to address the shortcomings of an external API when ingesting data into the data warehouse 104.

### Single Nodes and Streaming Nodes

When using the DMS 100, both single and streaming nodes can be implemented. Data ingestion might relate to ingesting, processing and writing data into a single record in an output table in the data warehouse 104, or it can relate to ingesting, processing and writing multiple records into an output table in the data warehouse 104. The multiple record ingestion and processing can occur one at a time or multiples at a time simultaneously. The data engineer using the DMS 100 is able to use a single protocol in defining a single record node or a streaming node, whereby the programming complexity of writing into single record or multiple record is performed for the data engineer in the background. For example, the data engineer is able to define a streaming node with a single line of code and the complexity of generating a new table, and appending the new table with one or more records are performed behind the scene. The data engineer can accomplish a streaming node with a single line definition.

In other words, the node 114 can include a dual processing feature, where the nodes inherit the methods for single and streaming functions enabling the data engineer to build node functions using single or streaming functionality arbitrarily. The complexity or data operations associated with the differences between single and streaming nodes are performed behind the curtains and the data engineer does not have to write those behind-the-scenes functions. For example, the DMS 100 and the data protocol 112 allow for table style transformation, streaming data transformation and streaming data processing within the same framework. Some examples of single nodes include nodes directed to listening to a web hook, for example, every time a “payment” is created, the node performs some logic, for example, receives a single record, performs a logic function on the record and outputs into the data warehouse 104. An example of aggregate processing that can be performed by a streaming node can include interfacing with a TDS 106 to ingest a batch of sensor data and updating a table of the sensor data in the data warehouse 104. The sensor data may relate to building a machine learning training data set.

### User Interface

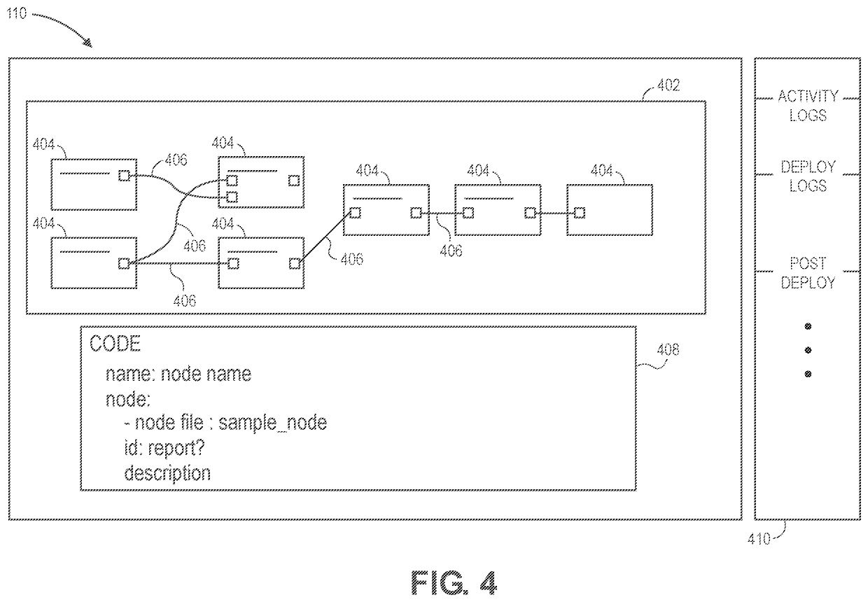

The DMS 100 can include a user interface 110, which presents an entire graph 108, and functionality related to creating, editing, execution and output observation of the graph 108 in one framework. FIG. 4 illustrates an example user interface (UI) 110. The UI 110 can include multiple regions depending on implementation. For example, a visual representation of the graph 108 can be presented in a graph panel 402. The graph panel 402 can include node visual representations (VR) 404 of the graph 108. The node VRs 404 correspond with the nodes 114 and can represent each node 114 as a rectangle having inputs and outputs. The node VRs 404 can be connected with edge VRs 406. Referencing FIGS. 2 and 4, each edge VR 406 corresponds to an edge 208 determined from the manifest 206. In this manner, a visual representation of the entire graph 108 can be presented in the UI 110. The user can click on a node VR 404 to view the node code underlying the selected node VR 404 in a code panel 408. In this manner, the user can efficiently cycle through various nodes and the underlying code, while visualizing the entire graph 108 in the UI 110. The DMS server 102 maintains the metadata and the node codes to generate the UI 110 and its various panels. In some embodiments, the UI 110 can include a result panel 410, where the user can view post run data, such as activity logs, deployment logs, and other deployment data.

In some embodiments, the UI 110 provides the user the ability to edit the graph 108 via the graph panel 402 and/or the code panel 408. User's edits entered via the UI 110 are received and used to generate a new version of the graph 108, which is presented again in the UI 110 by updating the graph panel 402, the code panel 408, and/or the result panel 410. The DMS server 102 keeps track of the versioning of the various iterations of the graph 108 as described above. Some embodiments of the UI 110 can forego of some of the UI features discussed above and/or may include other panels, depending on the implementation.

The output tables of the node runs are stored in the data warehouse 104, while the metadata of the various runs are stored in the DMS server 102. In this manner, the UI 110 can include various panels that enable the user to seamlessly navigate through the different runs and views of the graph 108 and views of the output tables stored in the data warehouse 104. For example, the UI 110 can include one or more panels of node descriptors, data tables, data versions, logs, deployment statuses, event logs, etc. Some nodes run on schedules and output into tables in the data warehouse 104. In these scenarios, the UI 110 can present panels that enable the user to access the multiple versions of the imported data via a table, allowing the user to scroll through multiple versions of the data within the same framework and via the UI 110, without having to configure an external tool. In other words, the DMS 100, including the UI 110, cam allow the users to develop, configure and deploy their data pipelines and visualize the pipeline (as well as test, modify the pipeline, and/or observe the output of the pipeline) all within a single framework, without having to custom code various database tools to implement the various stages of development, deployment and maintenance of their pipeline.

### Protocol

The DMS 100 includes a data protocol 112 that allows the user to define data pipeline specific instructions in fewer lines of code and without having to develop the code from scratch. In this manner, the protocol 112 moves the complexity of developing the data pipeline code to other layers invisible to the user of the DMS 100. For example, without the benefit of the DMS 100 and the data protocol 112, the extract, transform and load (ETL) operations can involve multiple tools and substantial coding and development effort to extract data from a TDS 106 API (extract operations), perform some processing (transform operations) and store the results into a data warehouse, such as the data warehouse 104 (load operations). Instead, all three of these operations can be written in one framework.

### Platform-Specific Importers Exporters

In the data management context, some TDS 106 can be commonly used for importing and exporting data. For example, payment processing vendors, sales data vendors, customer data vendors can be commonly used to retrieve raw data for downstream processing, for example by business intelligence (BI) data pipelines. In other domains, a specific TDS 106 can be commonly accessed to extract raw data for later downstream data processing in those domains. The same dynamic might exist at the exporting stage, where some TDS 120 can be the frequent destination for exporting processed data. The DMS 100 can provide a library of third-party-specific importers and/or exporters that already contain the code for retrieving data from a particular TDS 106. The user is also given access to the source code for the importers/exporters and/or the nodes. The user can modify the code according to a specific use case. In some embodiments, these third-party specific importers/exporters can be offered in a marketplace, where users of the DMS 100 can search and duplicate a specific importer based on their domain and their usage. Conversely, the users can contribute to this library by uploading DMS 100 objects, such as importers, exporters, nodes, etc. Example importers include Stripe® importers, Salesforce® importers, PayPal® importers, GitHub® importers, Slack® importers and others.

Another DMS 100 object is component object. The component object is a reusable graph made up of one or more nodes. A component object can be a utility or a collection of utilities, data flows, and/or other database operations. A SQL node, a deduplication node, or more complex flows, such as an entire underwriting model and/or an application-specific scoring system are amongst examples of component objects. The component object can be generated by a developer and offered via a marketplace or a library feature of the DMS 100. In some implementations, the component objects can be configured with a versioning mechanism, allowing the users of a component object to benefit from automatic updates to the component object dispatched from the developer of the component object. In some embodiments, the component objects can have exposed interface parameters and inputs/outputs, allowing them to be incorporated or cloned into another DMS 100 object, such as an app object. The app object, for example, can be found in a marketplace or a library of the DMS 100 objects. The app object can be an end-to-end data pipeline system, where the app object can incorporate other DMS 100 objects, including for example, one or more component objects, depending on the domain in which the app object is deployed. In other words, in some implementations, the component objects are used to implement specific tasks in a data pipeline, such as import/export data or other discrete data pipeline tasks, whereas app objects can be used to implement entire workflows of data pipelines. The library and/or the marketplace of importers/exporters and other DMS 100 objects can be offered as a panel in the UI 110 to facilitate access by the user of the DMS 100.

The details of the implementation of a particular importer depends on the TDS 106 and the domain in which the importer is used. In some embodiments, the library of importers/exporters can include entire graphs 108 coded for a task-specific data pipeline to be deployed on a selected TDS 106. The user of the DMS 100 can import (duplicate) an importer/exporter and/or an entire graph into their own development environment, configure the graph with their own selected API calls and use the duplicated graph 108 in their data pipeline. For example, a Salesforce® graph can be found in the library, cloned, and imported into a user's environment. The user can configure the graph with their API keys as parameters in the cloned graph and utilize the graph in their data pipeline. For example, a cloned graph can include a SQL node, which can calculate monthly recurring revenue (MRR). The cloned graph can also include importers 116 specific to Salesforce® that can interface with Salesforce® APIs to ingest the raw data needed for MRR. The cloned graph can also include nodes to load and transform the raw data to data from which the MRR can be generated. The cloned graph can also include nodes to generate and output the MRR, into a table output in the data warehouse 104, or other downstream outputs.

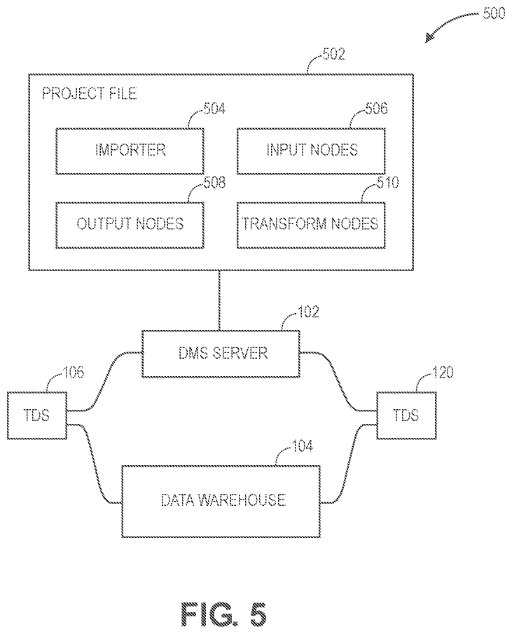

FIG. 5 illustrates a block diagram 500 of an example architecture of the DMS 100. The DMS 100 allows an entire data pipeline project to be defined in a single project file 502. The project file 502 can be source code for an entire graph 108. As described above, in some embodiments, the project file 502 can be cloned from a library of pre-configured project files directed to various data pipeline solutions in different domains. The project file 502 can include the nodes for implementing an end-to-end data pipeline solution from data ingestion stage to transformation and export stage. For example, the project file 502 can include source code for importer nodes 504, input nodes 506, output nodes 508 and transform nodes 510. The importer nodes 504 can perform data ingestion from a TDS 106 to the data warehouse 104. The input nodes 506 can include preliminary data operations, such as cleaning and reformatting, among other input stage functionality. In some embodiments, the importer nodes 504 and the input nodes 506 can be combined in their operations and implementation. The output and transform nodes 508 and 510 can perform various operations on the imported data on the data warehouse 104 and store output of the transformation in the data warehouse 104 or in one or more TDS 120. In some embodiments, the operations and functionality of the output nodes 508 and the transform nodes 510 can be combined. The illustrated categories of nodes in the single project file 502 are provided as examples only. A data engineer can configure more or fewer node categories and can combine or separate the functionality of a data pipeline between one or more nodes.

The details of the nodes depend on the deployment domain of the DMS 100, but some example nodes can include, nodes for cleaning data, deduplicating data, formatting the data into a particular table format, chart nodes, which are output nodes consuming a table of data and outputting various charts. Example charts in the business analytics domain include, revenue charts, customer life time value (LTV) charts, and others. The nodes can be Python, SQL, chart nodes or any other programming language and functionality.

The DMS server 102 receives the single project file 502 and executes the underlying data pipeline project defined by the project file 502. As described earlier, a data engineer is able to clone a preexisting project file 502 from a library of project files based on selected TDS 106, 120 and the type of data project pipeline. Without the advantage of a single project file 502, the different node functionalities embedded in the project file 502 may have to be performed across multiple tools and multiple frameworks, introducing substantial development efforts on the part of the data engineer to separately configure these tools across different platforms and program their integration to achieve the functionality of a data pipeline project. While the data engineer can define a project file 502 from scratch, and still realize the single framework advantages, the data engineer can in some cases save substantial programming time and development effort by duplicating and configuring a preexisting project file from a project library as described above.

In some embodiments, the project file 502 can include a description field for one or more nodes that enable the user of the DMS 100 to include a description (markdown) of a node's function. The description field can improve collaboration between data engineers working on the same data pipeline, as the comments and mark up in each description field helps reduce the cognitive loads in development and deployment across data pipeline team members.

In some embodiments, the project file 502 may include a local file structure, which includes node definition files (e.g., the nodes 504, 506, 508, 510) as well as a graph configuration file. The graph configuration file can include graph data such as node file paths, identifiers (IDs), names, description, inputs/outputs, and other settings, such as parameters (e.g., key/value pairs) and node trigger schedules. The node parameters can enable customizing the execution of a node, for example, a node parameter can be a text string, directing the node to execute when the input data includes the text string. Another example of a node parameter can enable linking the execution of a node to detecting a particular date or data range in the input. Other examples of node parameters include configuring a node with an integer variable, floating point variable, date/time variable and others.

The local file structure can enable a user to build an end-to-end data pipeline locally, using a text editor, while preserving the entire configuration of a graph for portability, development and deployment. The text editor can be independent from the DMS 100 or be a part of the UI 110. Alternatively, or in addition, the user can utilize a graphical user interface (GUI) in a web integrated development environment (IDE), as part of the UI 110 to define the project 502. In some embodiments, the project file 502 can be defined in a graph-friendly programming language, such as yet another mark-up language (YML). Alternatively, other programming languages can be used.

### Standardized Data Objects

Some data pipeline projects involve importing data from multiple TDS 106, aggregating the data, performing transformation, formatting the aggregated data, storing the transformed and formatted data, and in some cases producing an output from the aggregated data. Each TDS 106 can provide its data in its own format, which can complicate the downstream operations. A data engineer may have to write separate importers, transformers and output nodes, potentially for each TDS 106 in a data pipeline project. For example, the TDS 106 directed to payment processing, providing payment data, may each provide a payment data object in a different format. Similarly, customer relation management (CRM) vendors provide a customer data object in different formats. Sales data providers may provide sales or lead data objects in a variety of formats. The DMS 100 and the associated library of graphs, importers and nodes can provide standardized data objects in various domains, which can map the semantic meaning of the underlying data of a data object to a standardized data object. For example, the DMS 100 library can include a payment data importer, which can interface with the APIs of a variety of payment processors and produce a standardized payment data object, which the user of the DMS 100 can use for downstream data operations. The standardized data object can be generated by a variety of operations, depending on the domain and the underlying data. For example, part of generating the standardized data may include reformatting the data into a selected format, turning noisy data into a standardized and formatted data object, for example, by removing data columns, not commonly used, or by other operations depending on the domain and environment in which the data object will be used.

Data engineers using the standardized data objects on the DMS 100 over time can generate usage patterns in various data domains. The patterns of particular usages of the standardized data objects on the DMS 100 framework can be analyzed and used to generate preconfigured data pipeline projects, importers/exporters, node functions, data flows and/or entire use-specific or general graphs 108. Similarly, the usage of any of such objects within the DMS 100 framework can be tracked and analyzed for detecting usage patterns and generating preconfigured DMS 100 objects.

As described, examples of DMS 100 objects can include, the standardized data objects, importers/exporters, nodes (e.g., input node, output node, transformation nodes, chart nodes, compute nodes, logic nodes, etc.), partial or complete graphs (collection of nodes). Example usage patterns can include detecting that users commonly format data input from a vendor such as Stripe® or Salesforce® in a particular manner for their downstream operations, or the users commonly deploy a particular data flow when importing data from a particular vendor, or the users commonly generate a particular output transformation on the data warehouse 104 when importing data from a particular vendor, or the users commonly use a particular chart node when importing data from a vendor. In these examples, vendor-specific usage patterns across the DMS 100 framework over time can be used to generate library items of preconfigured DMS 100 objects.

These preconfigured objects can be added to the library of the DMS 100 and made searchable to the users of the DMS 100. In some embodiments, the patterns of uses of the standardized data objects, and/or other objects within the DMS 100, such as projects, nodes, importers/exporters, graphs can be used by a recommendation engine to match a user's detected use case to a library item. The user can clone the item from the library, modify it and/or reconfigure it, and use it in the user's specific data pipeline project.

### App or Application Object

Another DMS 100 object can be an app or an application object. An app object is a bundle of codes, nodes, graphs, and configuration files that define a data pipeline or data infrastructure. An app object can contain a set of nodes connected in a directed graph that together define the flow of data in a data infrastructure or a data pipeline. Various node types can combine to enable end-to-end data pipeline applications. Example types of nodes include operator nodes (e.g., Python, SQL, Webhook), storage nodes (e.g., Tablestore, Stream store), presentation nodes (e.g., Chart, Markdown). An app object can also contain dashboards. A dashboard is a view of a set of nodes in an app object. Dashboards can provide an interface to the user to assemble tables and charts together to create displays of data and analytics in a data pipeline project. In this manner, an app object can be an end-to-end data system, for example including data pipeline code, graph, interfaces and compute and storage in one DMS 100 object. An app object can also be cloned, and can be offered in a marketplace, so customers and/or developers can choose an end-to-end data pipeline solution according to their industry, application and/or usage.

In some embodiments, an app object can be a layered structure of the DMS 100, allowing users to build entire workflows, or end-to-end data pipelines. For example, an app object can include an interface node, a graph node, a code node, and a compute & storage node. All nodes of an app object and the app object itself can be cloned from a library of the DMS 100 objects. The interface nodes can provide various graphics user interfaces (GUIs), allowing a user of the DMS 100 library of objects to build GUIs compatible with their data pipelines implemented in app objects. Example interface nodes can include dashboards, business-intelligence tools, wire-back to database interfaces and external APIs (e.g., chart, or table exporters).

The graph nodes can be similar to graph 108, as described above. For example, graph nodes can allow a user deploying the graph node in their app object to define data pipeline orchestration via the graph node and build production-stage data pipelines with functional reactive execution protocols, based on other DMS 100 objects and nodes. The code node allows the user deploying the code node in their app object to build pipelines in programming languages of their choice, for example, in Python, in SQL and in others. In some embodiments, the code nodes can include version control, such as those implemented with GitHub, and released with continuous integration/continuous delivery (CI/CD), allowing the user embedding a code node to benefit from updates as they are dispatched by a developer of the code node. The compute & storage nodes when embedded in an app object can enable the data pipeline of the app object to run on any database or storage infrastructure defined by the compute & storage node or to perform processing of the data pipeline with any central processing unit (CPU), graphics processing unit (GPU) or tensor processing unit (TPU) machines defined by the compute & storage node. In this manner, an app object can be the definition, orchestration and execution of an end-to-end data pipeline system. The app objects can be provided in a library of objects of the DMS 100, where users can clone them and run them on their infrastructure and/or data project of their choice.

### Node Features

The DMS 100 nodes can include a variety of features. For example, in addition to graph version tracking, the nodes can include state management functionality, where a node can keep track of a state variable. The state variable can be directed to the state of any part of a data pipeline project or a particular execution of a graph, and/or state of the same node or other nodes within a graph 108. For example, a data pipeline project can be directed to importing voluminous data from a popular news and commentary site or any website into the data warehouse 104 and performing various downstream operations on the imported data. A data pipeline project in this scenario can include operations such as importing the voluminous data in several batches. An importer node can keep track of the last item imported. If the import operations fail for any reason, the state variable of the importer node can be queried and used to resume the import from the last imported record. This functionality can be useful in importing from third-party APIs, as they can fail for a variety of reasons, such as API downtime, time-out errors, function run-time limits, memory/storage limits, etc. However, the node state variables can be used in other contexts within a data pipeline project. In some embodiments, the state variable can be a Python (or another programming language) dictionary, list, date/time, etc. The state variable resides on the node and persists through executions (runs) of the node.

The node can include trigger functionality, where the execution of a node can depend on occurrence of one or more selected conditions, in addition to any upstream dependencies the node may have. Trigger functionality can include manual, or scheduled execution. Manual trigger can include executing a node after receiving a command line or other input from the user. Scheduled triggers in the context of data management can be used in a variety of applications, for example, when importing data from a TDS 106 and/or exporting data into a TDS 120 on a scheduled basis. For example, scheduled triggers can be used in scenarios when the data pipeline project calls for importing data at a particular date and time, and/or on a recurring basis, such as daily, hourly, weekly, etc. Scheduled triggers can also be used to automate graph runs.

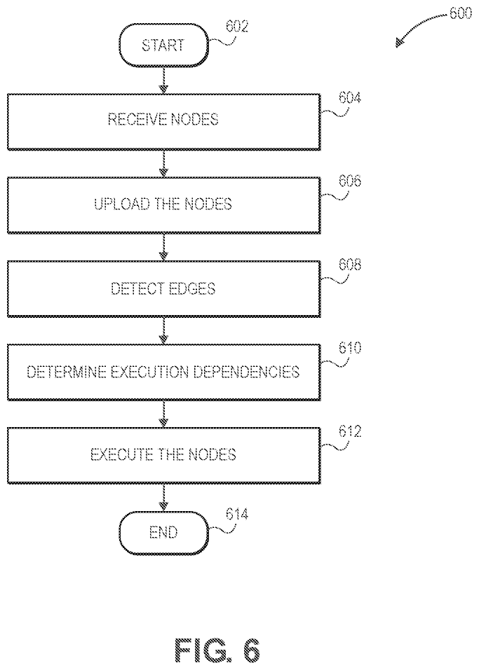

FIG. 6 illustrates a method 600 of an example operation of the DMS 100. The method starts at step 602. At 604, a plurality of node definitions is received, for example by the DMS server 102 or by a locally installed devkit. The nodes together define a data pipeline project involving data operations, such as data ingestion, data transformation and data output. In some embodiments, the node may be preconfigured nodes that the user cloned from a library provided by the administrator of the DMS 100 and provided to the DMS server 102 as is or after user modifications. In some embodiments, the user can also provide a graph configuration file. The graph configuration file can include global graph data, such as input/output pairs and other global graph parameters. At step 606, the nodes and the graph configuration file are uploaded to the DMS server 102. Alternatively, in some embodiments, some of the steps of the method 600 are performed locally in the user's local computer. At step 608, the nodes and/or the graph configuration file are parsed. The input/output pairs of each node are determined. From the input/output pairs, graph edges are detected. At step 610, the graph edges, for example, graph edges 208 illustrated in FIG. 2 are used to determine execution dependencies of the graph defined by the nodes. The graph edges 208 can also be used in generating the UI 110, as described above in relation to the embodiment of FIG. 4. At step 612, the DMS server 102 executes the nodes based on graph parameters defined in the graph configuration file and based on the determined execution dependencies. The execution step 612 may be repeated, as the case may be if the nodes specify it. The method ends at step 614.

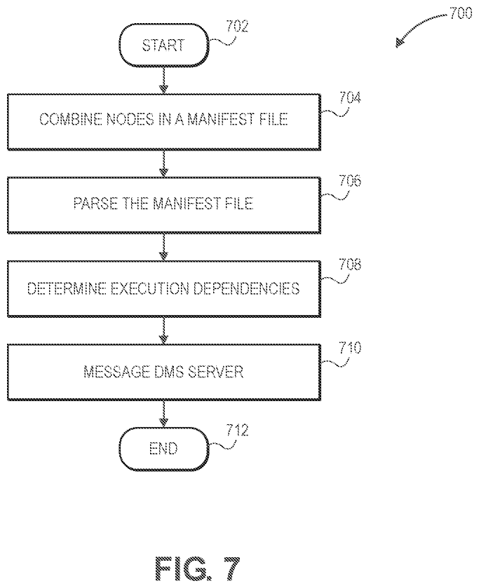

FIG. 7 illustrates a method 700 of an example operation of preparing a graph for execution. The method starts at step 702. At step 704, a plurality of nodes is combined in a manifest file. At step 706, a manifest compute (e.g., one similar or identical to the manifest compute 204 as discussed in relation to the embodiment of FIG. 2) can parse the manifest file and search for input/output pairs between the nodes in the manifest file. At step 708, the node input/output pairs are used to determine graph edges and execution dependencies of the graph. At step 710, the graph (e.g., the collection of the nodes and the graph parameters if one is used) are uploaded to the DMS server 102. The method ends at step 712.

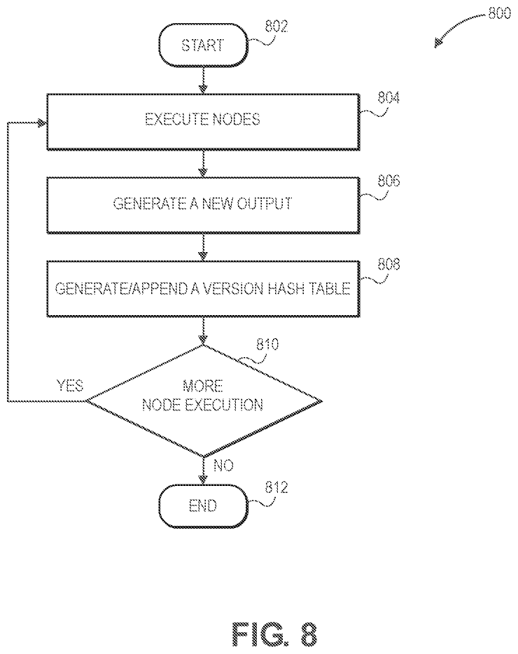

FIG. 8 illustrates a method 800 of an example data pipeline execution. The data pipeline can be defined for the DMS 100, using a plurality of nodes. The nodes can identify a computational graph or a data graph of the data pipeline project. The DMS 100 can receive the nodes and prepare the data pipeline for execution, for example, using the embodiment of FIG. 7. The method starts at step 802. At step 804, the DMS server 102 executes the nodes. At step 806, the execution of the nodes can generate or modify a new output in a data warehouse. At step 808, a version hash table is generated if one from previous runs (executions) does not exist. Alternatively, if a version hash table exists, the has table is appended with metadata of the newly generated output. The version hash table can contain a mapping of the various runs of a graph relative to the generated output, as well as other metadata, such as run timing, source and destination servers, and other metadata as the nodes may specify. At step 810, the DMS server 102 determines whether more runs of the graph are specified (e.g., by the nodes). If yes, the method moves back to the step 804 and repeats steps 804-810. For each iteration, the output stored in data warehouse 104 is not overwritten; instead, for each run, a new output is generated and stored in the data warehouse 104. If, at step 810, there are no more executions, the method ends at step 812.

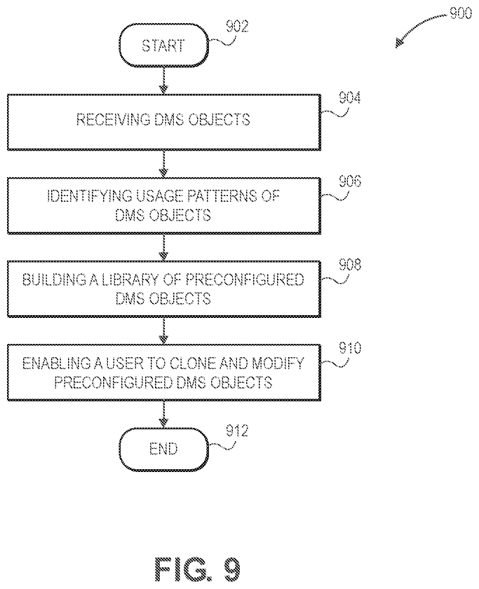

FIG. 9 illustrates a method 900 of generating and using a library of DMS objects. The method starts at step 902. At step 904, a plurality of nodes, graphs, and/or other DMS objects (such as importer nodes, transform nodes, etc.) are received from a plurality of users. The DMS objects may be received from a substantial number of users of the DMS 100. At step 906, usage patterns of the DMS objects are determined. The usage patterns can occur in relation to the tasks performed by the DMS objects, and/or they can occur in relation to the third-party servers that are sources and destinations of the data handled by the DMS objects. The usage patterns can be identified by a variety of methods. For example, supervised and unsupervised artificial intelligence methods can be used to identify usage patterns, or the DMS objects can be manually analyzed to determine usage patterns, or patterns can be identified by surveying the users of the DMS 100, or via other methods.

At step 908, the usage patterns can be used to generate a library of preconfigured DMS objects, such as nodes, collection of nodes, importers, exporters, transform nodes, entire data pipeline graphs and/or other DMS objects. At step 910, the DMS 100 enables a user to search, identify and clone a preconfigured node for a selected task. In other embodiments, the DMS 100 can use a recommendation engine that identifies or predicts a user's selected task and makes a recommendation from the library of preconfigured DMS objects. The user is able to deploy a preconfigured DMS object, as-is, or modify it according to the user's specifications. The step 910 may be facilitated or implemented by the UI 110. The recommendation engine can be an AI-based recommendation engine, matching predicted user task to preconfigured DMS objects, and/or it can be implemented with a look-up table, matching a user's profile to DMS objects corresponding to the user's profile. The method ends at step 912.

### Example Implementation Mechanism—Hardware Overview

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

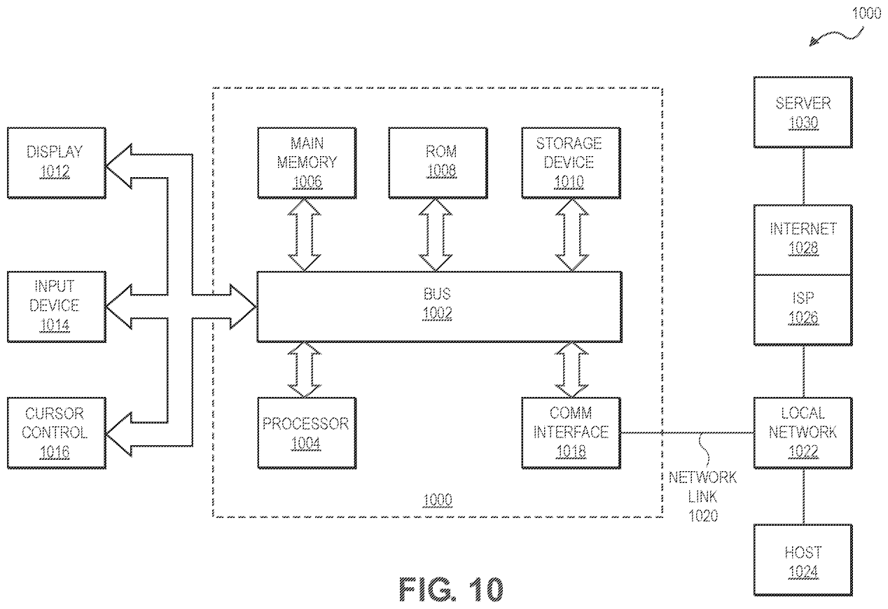

For example, FIG. 10 is a block diagram that illustrates a computer system 1000 upon which an embodiment of can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted or received in video conferencing architectures.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state disk is provided and coupled to bus 1002 for storing information and instructions.

Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### Examples

It will be appreciated that the present disclosure may include any one and up to all of the following examples.

Example 1: A method comprising: receiving, from a user, a plurality of nodes, the nodes comprising an end-to-end data pipeline graph, wherein each node comprises an operation of the data pipeline, the operations comprising ingesting data from a third-party server into an external data warehouse; receiving, from the user, a graph configuration file comprising inputs and outputs of each node; uploading the nodes and the graph configuration file to a database management (DMS) server; detecting graph edges by parsing the nodes and/or the graph configuration file; detecting input/output pairs between the nodes, wherein each pair of input/output comprises an edge of the graph, wherein the edges further determine execution dependencies of the nodes; executing the nodes according to the graph edges and the graph configuration file; generating an output in the external data warehouse.

Example 2: The method of Example 1, wherein the nodes comprise a third-party-specific importer node configured to interface with an application programming interface of the third-party server and import data from the third-party server to the data warehouse.

Example 3: The method of some or all of Examples 1 and 2, further comprising: providing a library of nodes comprising preconfigured data pipeline graphs specific to the third-party server and/or a data pipeline project related to the third-party server; enabling the user to clone and/or modify a node, a collection of nodes, and/or a preconfigured data pipeline graph downloaded from the library.

Example 4: The method of some or all of Examples 1-3, wherein executing the nodes further comprise a completed node sending a message via a message queue, the message comprising an indication of completion of an execution by the completed node, wherein upon receiving the message, the DMS server executes nodes having execution dependencies on the completed node.

Example 5: The method of some or all of Examples 1-4 further comprising: providing a user interface, comprising a graph panel, the graph panel providing a visual representation of the end-to-end data pipeline graph by: displaying a plurality of rectangles, each rectangle representing a node of the graph, connecting the rectangles with lines based on whether a graph edge exists between the nodes corresponding to the rectangles.

Example 6: The method of some or all of Examples 1-5, wherein the nodes further comprise: an importer node configuring the external data warehouse to perform operations comprising: ingesting data from the third-party server; generating a table from the imported data, based on a selected format; and a chart node generating a chart based on the table and configuring the external data warehouse to store the chart.

Example 7: The method of some or all of Examples 1-6, wherein the nodes further comprise one or more of a single record node and streaming node, wherein the single record node configures the external data warehouse to write single records into an output table in the data warehouse and the streaming node configures the external data warehouse to write multiple records in the output table in the data warehouse.

Example 8: The method of some or all of Examples 1-7 further comprising: providing a library of nodes, wherein the nodes are preconfigured to import data from a plurality of third-party servers and generate standardized data objects, based on semantic meaning of the ingested data, such that data imported from the plurality of the third-party servers is presented in a common format in the standardized data object.

Example 9: A non-transitory computer storage that stores executable program instructions that, when executed by one or more computing devices, configure the one or more computing devices to perform operations comprising: receiving, from a user, a plurality of nodes, the nodes comprising an end-to-end data pipeline graph, wherein each node comprises an operation of the data pipeline, the operations comprising ingesting data from a third-party server into an external data warehouse; receiving, from the user, a graph configuration file comprising inputs and outputs of each node; uploading the nodes and the graph configuration file to a database management (DMS) server; detecting graph edges by parsing the nodes and/or the graph configuration file; detecting input/output pairs between the nodes, wherein each pair of input/output comprises an edge of the graph, wherein the edges further determine execution dependencies of the nodes; executing the nodes according to the graph edges and the graph configuration file; generating an output in the external data warehouse.

Example 10: The non-transitory computer storage of Example 9, wherein the nodes comprise a third-party-specific importer node configured to interface with an application programming interface of the third-party server and import data from the third-party server to the data warehouse.

Example 11: The non-transitory computer storage of some or all of Examples 9 and 10, wherein the operations further comprise: providing a library of nodes comprising preconfigured data pipeline graphs specific to the third-party server and/or a data pipeline project related to the third-party server; enabling the user to clone and/or modify a node, a collection of nodes, and/or a preconfigured data pipeline graph downloaded from the library.

Example 12: The non-transitory computer-storage of some or all of Examples 9-11, wherein executing the nodes further comprise a completed node sending a message via a message queue, the message comprising an indication of completion of an execution by the completed node, wherein upon receiving the message, the DMS server executes nodes having execution dependencies on the completed node.

Example 13: The non-transitory computer storage of some or all of Examples 9-12, wherein the operations further comprise: providing a user interface, comprising a graph panel, the graph panel providing a visual representation of the end-to-end data pipeline graph by: displaying a plurality of rectangles, each rectangle representing a node of the graph, connecting the rectangles with lines based on whether a graph edge exists between the nodes corresponding to the rectangles.

Example 14: The non-transitory computer-storage of some or all of Examples 9-13, wherein the nodes further comprise: an importer node configuring the external data warehouse to perform operations comprising: ingesting data from the third-party server; generating a table from the imported data, based on a selected format; and a chart node generating a chart based on the table and configuring the external data warehouse to store the chart.

Example 15: The non-transitory computer-storage of some or all of Examples 9-14, wherein the nodes further comprise one or more of a single record node and streaming node, wherein the single record node configures the external data warehouse to write single records into an output table in the data warehouse and the streaming node configures the external data warehouse to write multiple records in the output table in the data warehouse.

Example 16: The non-transitory computer storage of some or all of Examples 9-15, wherein the operations further comprise: providing a library of nodes, wherein the nodes are preconfigured to import data from a plurality of third-party servers and generate standardized data objects, based on semantic meaning of the ingested data, such that data imported from the plurality of the third-party servers is presented in a common format in the standardized data object.

Example 17: A data management server (DMS) configured to perform operations comprising: receiving, from a user, a plurality of nodes, the nodes comprising an end-to-end data pipeline graph, wherein each node comprises an operation of the data pipeline, the operations comprising ingesting data from a third-party server into an external data warehouse; receiving, from the user, a graph configuration file comprising inputs and outputs of each node; detecting graph edges by parsing the nodes and/or the graph configuration file; detecting input/output pairs between the nodes, wherein each pair of input/output comprises an edge of the graph, wherein the edges further determine execution dependencies of the nodes; executing the nodes according to the graph edges and the graph configuration file; generating an output in the external data warehouse.

Example 18: The system of Example 17, wherein the nodes comprise a third-party-specific importer node configured to interface with an application programming interface of the third-party server and import data from the third-party server to the data warehouse.

Example 19: The system of some or all of Examples 17 and 18, further comprising: a library of nodes comprising preconfigured data pipeline graphs specific to the third-party server and/or a data pipeline project related to the third-party server, wherein the user is enabled to clone and/or modify a node, a collection of nodes, and/or a preconfigured data pipeline graph downloaded from the library.

Example 20: The system of some or all of Examples 17-19, wherein executing the nodes further comprise a completed node sending a message via a message queue, the message comprising an indication of completion of an execution by the completed node, wherein upon receiving the message, the DMS server executes nodes having execution dependencies on the completed node.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed is:

1. A method comprising:
receiving, from a user, a plurality of nodes, the nodes comprising an end-to-end data pipeline graph, wherein each node comprises an operation of the data pipeline, the operations comprising ingesting data from a third-party server into an external data warehouse;
receiving, from the user, a graph configuration file comprising inputs and outputs of each node;
uploading the nodes and the graph configuration file to a database management (DMS) server;
detecting graph edges by parsing the nodes and/or the graph configuration file;
detecting input/output pairs between the nodes, wherein each pair of input/output comprises an edge of the graph, wherein the edges further determine execution dependencies of the nodes;
executing the nodes according to the graph edges and the graph configuration file;
generating an output in the external data warehouse.

2. The method of claim 1, wherein the nodes comprise a third-party-specific importer node configured to interface with an application programming interface of the third-party server and import data from the third-party server to the data warehouse.

3. The method of claim 1, further comprising:
providing a library of nodes comprising preconfigured data pipeline graphs specific to the third-party server and/or a data pipeline project related to the third-party server;
enabling the user to clone and/or modify a node, a collection of nodes, and/or a preconfigured data pipeline graph downloaded from the library.

4. The method of claim 1, wherein executing the nodes further comprise a completed node sending a message via a message queue, the message comprising an indication of completion of an execution by the completed node, wherein upon receiving the message, the DMS server executes nodes having execution dependencies on the completed node.

5. The method of claim 1 further comprising:
providing a user interface, comprising a graph panel, the graph panel providing a visual representation of the end-to-end data pipeline graph by:
displaying a plurality of rectangles, each rectangle representing a node of the graph,
connecting the rectangles with lines based on whether a graph edge exists between the nodes corresponding to the rectangles.

6. The method of claim 1, wherein the nodes further comprise:
an importer node configuring the external data warehouse to perform operations comprising:
ingesting data from the third-party server;
generating a table from the imported data, based on a selected format; and
a chart node generating a chart based on the table and configuring the external data warehouse to store the chart.

7. The method of claim 1, wherein the nodes further comprise one or more of a single record node and streaming node, wherein the single record node configures the external data warehouse to write single records into an output table in the data warehouse and the streaming node configures the external data warehouse to write multiple records in the output table in the data warehouse.

8. The method of claim 1 further comprising:
providing a library of nodes, wherein the nodes are preconfigured to import data from a plurality of third-party servers and generate standardized data objects, based on semantic meaning of the ingested data, such that data imported from the plurality of the third-party servers is presented in a common format in the standardized data object.

9. A non-transitory computer storage that stores executable program instructions that, when executed by one or more computing devices, configure the one or more computing devices to perform operations comprising:
receiving, from a user, a plurality of nodes, the nodes comprising an end-to-end data pipeline graph, wherein each node comprises an operation of the data pipeline, the operations comprising ingesting data from a third-party server into an external data warehouse;
receiving, from the user, a graph configuration file comprising inputs and outputs of each node;
uploading the nodes and the graph configuration file to a database management (DMS) server;
detecting graph edges by parsing the nodes and/or the graph configuration file;
detecting input/output pairs between the nodes, wherein each pair of input/output comprises an edge of the graph, wherein the edges further determine execution dependencies of the nodes;
executing the nodes according to the graph edges and the graph configuration file;
generating an output in the external data warehouse.

10. The non-transitory computer storage of claim 9, wherein the nodes comprise a third-party-specific importer node configured to interface with an application programming interface of the third-party server and import data from the third-party server to the data warehouse.

11. The non-transitory computer storage of claim 9, wherein the operations further comprise:
providing a library of nodes comprising preconfigured data pipeline graphs specific to the third-party server and/or a data pipeline project related to the third-party server;
enabling the user to clone and/or modify a node, a collection of nodes, and/or a preconfigured data pipeline graph downloaded from the library.

12. The non-transitory computer-storage of claim 9, wherein executing the nodes further comprise a completed node sending a message via a message queue, the message comprising an indication of completion of an execution by the completed node, wherein upon receiving the message, the DMS server executes nodes having execution dependencies on the completed node.

13. The non-transitory computer storage of claim 9, wherein the operations further comprise:
providing a user interface, comprising a graph panel, the graph panel providing a visual representation of the end-to-end data pipeline graph by:
displaying a plurality of rectangles, each rectangle representing a node of the graph,
connecting the rectangles with lines based on whether a graph edge exists between the nodes corresponding to the rectangles.

14. The non-transitory computer-storage of claim 9, wherein the nodes further comprise:
an importer node configuring the external data warehouse to perform operations comprising:
ingesting data from the third-party server;
generating a table from the imported data, based on a selected format; and
a chart node generating a chart based on the table and configuring the external data warehouse to store the chart.

15. The non-transitory computer-storage of claim 9, wherein the nodes further comprise one or more of a single record node and streaming node, wherein the single record node configures the external data warehouse to write single records into an output table in the data warehouse and the streaming node configures the external data warehouse to write multiple records in the output table in the data warehouse.

16. The non-transitory computer storage of claim 9, wherein the operations further comprise:
providing a library of nodes, wherein the nodes are preconfigured to import data from a plurality of third-party servers and generate standardized data objects, based on semantic meaning of the ingested data, such that data imported from the plurality of the third-party servers is presented in a common format in the standardized data object.

17. A data management server (DMS) configured to perform operations comprising:
receiving, from a user, a plurality of nodes, the nodes comprising an end-to-end data pipeline graph, wherein each node comprises an operation of the data pipeline, the operations comprising ingesting data from a third-party server into an external data warehouse;
receiving, from the user, a graph configuration file comprising inputs and outputs of each node;
detecting graph edges by parsing the nodes and/or the graph configuration file;
detecting input/output pairs between the nodes, wherein each pair of input/output comprises an edge of the graph, wherein the edges further determine execution dependencies of the nodes;
executing the nodes according to the graph edges and the graph configuration file;
generating an output in the external data warehouse.

18. The system of claim 17, wherein the nodes comprise a third-party-specific importer node configured to interface with an application programming interface of the third-party server and import data from the third-party server to the data warehouse.

19. The system of claim 17, further comprising:
a library of nodes comprising preconfigured data pipeline graphs specific to the third-party server and/or a data pipeline project related to the third-party server, wherein the user is enabled to clone and/or modify a node, a collection of nodes, and/or a preconfigured data pipeline graph downloaded from the library.

20. The system of claim 17, wherein executing the nodes further comprise a completed node sending a message via a message queue, the message comprising an indication of completion of an execution by the completed node, wherein upon receiving the message, the DMS server executes nodes having execution dependencies on the completed node.
